(19) United States
(12) Patent Application Publication
(10) Pub. No.: US 2022/0281174 A1
(43) Pub. Date: Sep. 8, 2022

(54) PHOTO-CURING THREE DIMENSIONAL PRINTING PREVIEW METHOD

(71) Applicants: Donghua University, Shanghai (CN); Jiangsu Academy of Agricultural Sciences, Jiangsu (CN)

(72) Inventors: Qingbao GUAN, Shanghai (CN); Zhengwei YOU, Shanghai (CN); Yi GAO, Shanghai (CN); Yang ZHAO, Shanghai (CN); Lei XU, Jiangsu (CN); Nina YAN, Jiangsu (CN)

(73) Assignees: Donghua University, Shanghai (CN); Jiangsu Academy of Agricultural Sciences, Jiangsu (CN)

(21) Appl. No.: 17/771,019

(22) PCT Filed: Nov. 14, 2019
(86) PCT No.: PCT/CN2019/118315

§ 371 Date: Apr. 22, 2022

(30) Foreign Application Priority Data
Oct. 23, 2019 (CN) 201911012217.3

(51) Int. Cl. B29C 64/386; B29C 64/124; B33Y 50/00; G05B 19/4099

(52) U.S. Cl. CPC B29C 64/386; B29C 64/124; B33Y 50/00; G05B 19/4099; G05B 2219/49023

(57) ABSTRACT

A photo-curing three-dimensional printing preview method, comprising: obtaining the relationship of the conversion rate of a photosensitive resin system versus time under different curing conditions by measuring the relationship between the absorbance of the photosensitive resin system under different curing conditions and the time; fitting on experimental curves on the basis of a photo-curing kinetic equation by an iterative solution method, and obtaining a photo-curing kinetic constant of the photosensitive resin system; solving a photo-curing reaction kinetic differential equation set by using a fixed-step Euler method, and obtaining the relationship curves of the spatial distribution of each component content of the photosensitive resin system versus time; and conducting simulation printing, in conjunction with the relationship curves obtaining a space distribution of each component content in each layer of structure in a three-dimensional printing product after printing is completed, and completing a photo-curing three-dimensional printing preview.

### TECHNICAL FIELD

The present disclosure relates to the technical field of photo-curing three dimensional printing simulation, in particular to a photo-curing three dimensional printing preview method.

### DESCRIPTION OF RELATED ART

Three Dimensional Printing (3DP) is a novel rapid prototyping technology developed by relying on electronic information, mechanical processing, sensors and new material development, has the incomparable advantages of design and manufacturing integration, short production cycle, low cost and the like compared with a forced forming technology like traditional planing and milling, is known as “manufacturing technology with industrial revolution significance”, and has been widely used in tissue engineering, industrial manufacturing, energy materials, aerospace and other fields. Compared with other 3DP technologies, photo-curing three dimensional printing has the advantages of high forming accuracy, low cost, and diversified design of functional photosensitive resins, thereby making it one of the most popular 3DP technologies at present.

Photo-curing three dimensional printing uses UV light to irradiate thin layers of liquid photosensitive resins for stacking molding, and light-induced thermosetting liquid resins undergo cross-linking reaction between layers under UV light irradiation. Therefore, printing settings that affect the reaction kinetics, such as a slicing layer thickness, the printing time of each layer and the UV light source light intensity will affect the printing effect and quality of a finished product, the debugging process wastes more time and labor than 2D printing, and materials are prone to be wasted. Compared with 2D printing editing software with a built-in print preview function, such as OFFICE series, 3DP, especially photo-curing three dimensional printing control software involving cross-linking reaction, needs to introduce a printing preview function in addition to a slicing function to help users guide printing settings and even automatically design and compare printing setting solutions based on imported graphics.

### SUMMARY

The technical problem to be solved by the present disclosure is to provide a photo-curing three dimensional printing preview method, which simulates a resin layer conversion rate of a printed part under printing settings by combining a 3DP layer-by-layer stacking mechanism and a photo-curing cross-linking kinetic principle so as to characterize a preview effect.

The technical solution adopted by the present disclosure to solve the technical problem is as follows: a photo-curing three dimensional printing preview method is provided, and includes the following steps:

(1) obtaining a relationship curve between a conversion rate and time of a photosensitive resin system under different curing conditions by measuring a relationship between an absorbance and time of the photosensitive resin system under different curing conditions;

(2) fitting an experimental curve by using an iterative solution method based on a photo-curing kinetic equation, obtaining a photo-curing kinetic constant of the photosensitive resin system, and establishing a photo-curing reaction kinetic differential equation set;

(3) solving the photo-curing reaction kinetic differential equation set by using a fixed-step Euler method, and obtaining a spatial distribution and time relationship curve of a content of each component of the photosensitive resin system in a photo-curing reaction process;

(4) measuring a relationship curve between an incident light transmissivity and a thickness of a cured product before and after a photo-curing reaction of the photosensitive resin system through an ultraviolet spectrum; and

(5) performing simulated printing according to a structure of a three dimensional printing product, a light source intensity, a layer thickness and single-layer printing time, obtaining spatial distribution of the content of each component in each layer structure in the three dimensional printing product after printing is completed by combining with the spatial distribution and time relationship curve of the content of each component of the photosensitive resin system in the photo-curing reaction process, and completing photo-curing three dimensional printing preview.

The step (1) is specifically as follows: measuring a change situation of an absorbance of functional groups with time in 3-7 groups of photosensitive resins under the different curing conditions by using an in-situ Fourier transform infrared spectrometer, and converting the change situation into a change curve of the conversion rate with time through an internal standard method, wherein, the different curing conditions include different UV light source intensities and different photoinitiator contents.

The photo-curing kinetic constant obtained in the step (2) includes a chain initiation constant, a chain growth constant and a termination constant.

The photo-curing reaction kinetic differential equation set in the step (2) is obtained by simultaneously obtaining reaction rate equations including initiator decomposition, chain initiation, chain growth, and chain termination.

### Beneficial Effects

Due to the adoption of the above-mentioned technical solution, the present disclosure has the following advantages and positive effects compared with the prior art: the present disclosure can obtain a kinetic parameter input value of an unknown or arbitrary formula photosensitive resin system by a method for combining an infrared spectrum and the UV spectrum to characterize a photosensitive resin stacking curing property, thereby making a simulation result more realistic. Combining a classical free radical polymerization kinetic model introduced with oxygen inhibition and a light attenuation principle, a method for realizing the simulation of a photo-curing three dimensional printing preview effect provided by the present disclosure makes up for the blank of three dimensional printing control software on the aspect of the preview function.

### BRIEF DESCRIPTION OF THE DRAWINGS

FIG. 1 is an installation diagram of an in-situ photo-curing Fourier transform infrared spectrometer optical path system and a liquid resin sample provided by an embodiment of the present disclosure.

FIG. 2 is a monomer infrared spectrum absorption characteristic peak-monomer concentration curve diagram provided by an embodiment of the present disclosure.

FIG. 3 is a monomer conversion curve diagram of different curing parameters obtained by infrared spectrum data and simulation calculation data provided by an embodiment of the present disclosure.

FIG. 4 is a diagram of a calculation result of a photosensitive resin kinetic constant provided by an embodiment of the present disclosure.

FIG. 5 is a diagram of a calculation result of a photo-curing three dimensional printing simulation cured layer thickness provided by an embodiment of the present disclosure.

FIG. 6 is a diagram of a curing effect of photo-curing three dimensional printing simulation with different exposure times provided by an embodiment of the present disclosure.

### DESCRIPTION OF THE EMBODIMENTS

The present disclosure will be further described below with reference to specific embodiments. It should be understood that these embodiments are merely illustrative of the present disclosure and are not intended to limit the scope of the present disclosure. In addition, it should be understood that after reading the content taught by the present disclosure, those skilled in the art can make various changes or modifications to the present disclosure, and these equivalent forms also fall within the scope defined by the appended claims of the present application.

An implementation of the present disclosure relates to a photo-curing three dimensional printing preview method. The method is based on a free radical cross-linking reaction model, since a three dimensional printing process is usually carried out in an air atmosphere, and oxygen captures active free radicals generated in the reaction process, an oxygen inhibition model is introduced into classical chain initiation, chain growth and chain termination mechanisms; and a fixed-step Euler method is used to solve a kinetic differential equation set, a time-varying value of each variable is derived, and according, a simulated three dimensional printing preview effect is achieved. The method specifically includes the following steps.

(1) A relationship curve between a conversion rate and time of a photosensitive resin system under different curing conditions is obtained by measuring a relationship between an absorbance and time of the photosensitive resin system under different curing conditions, specifically: a change situation of an absorbance of functional groups with time in 3-7 groups of photosensitive resins under the different curing conditions (different UV light source intensities, different photoinitiator contents and the like) is measured by using an in-situ Fourier transform infrared spectrometer, and converted into a change curve of the conversion rate with time through an internal standard method.

(2) An experimental curve is fitted by using an iterative solution method based on a photo-curing kinetic equation according to the relationship curve between the conversion rate and time of the photosensitive resin system under the different curing conditions, and a photo-curing kinetic constant of the photosensitive resin system is obtained by calculation. For the same curing system, the kinetic constant (a chain initiation constant, a chain growth constant, and a termination constant) that conform to each experimental curve may be calculated according to the change curve of the conversion rate with time under several input sets of different settings. The parameters of the free radical photopolymerization of photosensitive resins involved in the calculation may be set according to experimental measurement results and the actual needs of photo-curing printing, specifically including calculation parameters such as a calculation step size, a grid size, and an area size, curing parameters such as a light source intensity, a layer thickness and an exposure time of single layer, and physical properties such as resin monomer and initiator densities, a molar absorption coefficient, a temperature, and an initial molar concentration.

(3) The photo-curing reaction kinetic differential equation set is solved by using a fixed-step Euler method, and a spatial distribution and time relationship curve of a content of each component of the photosensitive resin system in a photo-curing reaction process is obtained.

(4) A relationship curve between an incident light transmissivity and a thickness of a cured product before and after a photo-curing reaction of the photosensitive resin system is measured through a UV spectrum.

(5) Simulated printing is performed according to a structure of a three dimensional printing product, the light source intensity, the layer thickness, and single-layer printing time; spatial distribution of a content of each component in each layer structure in the three dimensional printing product after printing is completed is obtained by combining with the spatial distribution and time relationship curve of the content of each component of the photosensitive resin system in the photo-curing reaction process, and photo-curing three dimensional printing preview is completed.

In the process of simulating layer-by-layer curing and superposition, the present disclosure collects the change situation of the absorbance of the functional groups with time through an infrared spectrum, converts it into the change curve of the conversion rate with time through the internal standard method, and then obtains the kinetic constant, thereby obtaining the spatial distribution of the content of each component in the reaction process, the value may be represented by data or by a gradient color, and the spatial distribution is reflected by displaying a spatial content diagram of any component according to a selected section.

The present disclosure will be further described below through a specific embodiment.

Step 1, a photosensitive resin curing infrared spectrum is collected.

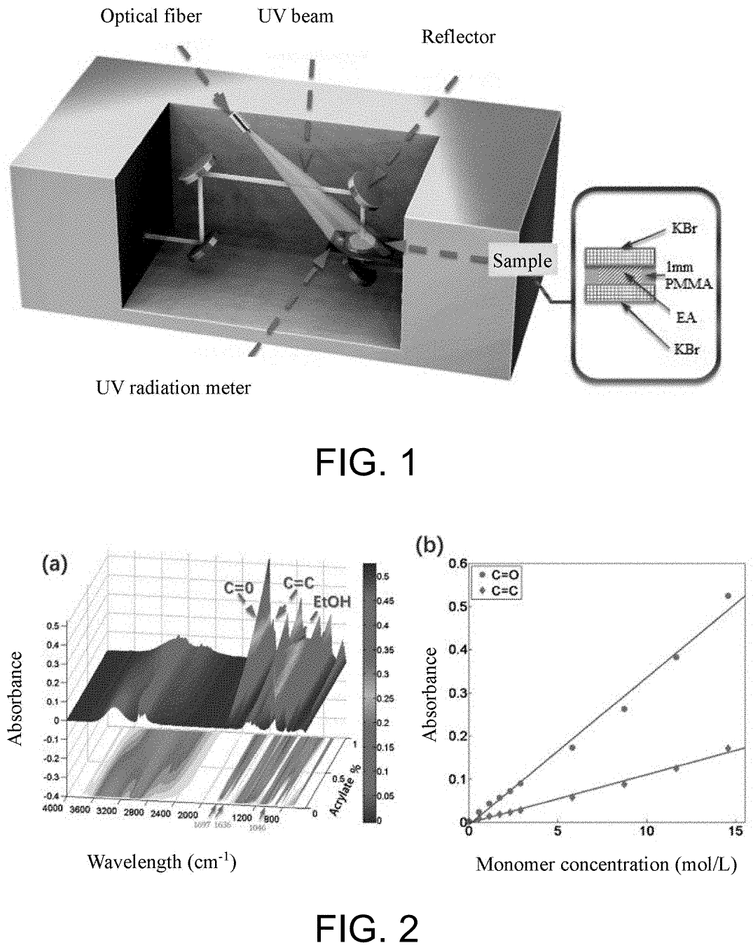

Epoxy acrylic resins containing 1%, 2% and 3% of 2,4,6-trimethylbenzoyl-diphenylphosphine oxide are prepared separately and divided into three groups for experiments. For each group of resins, an in-situ photo-curing Fourier transform infrared spectrometer is adopted to achieve in-situ infrared spectrum detection by UV light curing through an optical path system: UV light is projected onto the surface of a sample through an optical fiber, and an energy density of a light source is measured by a UV light power meter to realize closed-loop control. The liquid resin is placed between two potassium bromide tablets with a thickness of 1 mm and is surrounded by a ring member to fix a thickness and prevent leakage of a liquid monomer. An infrared light source enters a detector after passing through the sample to be tested, and a computer measures the infrared spectrum of the sample at regular intervals. Installation of an in-situ photo-curing Fourier transform infrared spectrometer optical path system and a liquid resin sample is shown in FIG. 1. As can be seen in FIG. 1, the optical fiber is installed in a position to project the light from a curing light source, cover the surfaces of the potassium bromide tablets and cover a UV detector area. At the same time, an infrared beam passes through a mounted mirror, passes through the sample, and enters an infrared detector.

Step 2, photosensitive resin kinetic parameters are calculated.

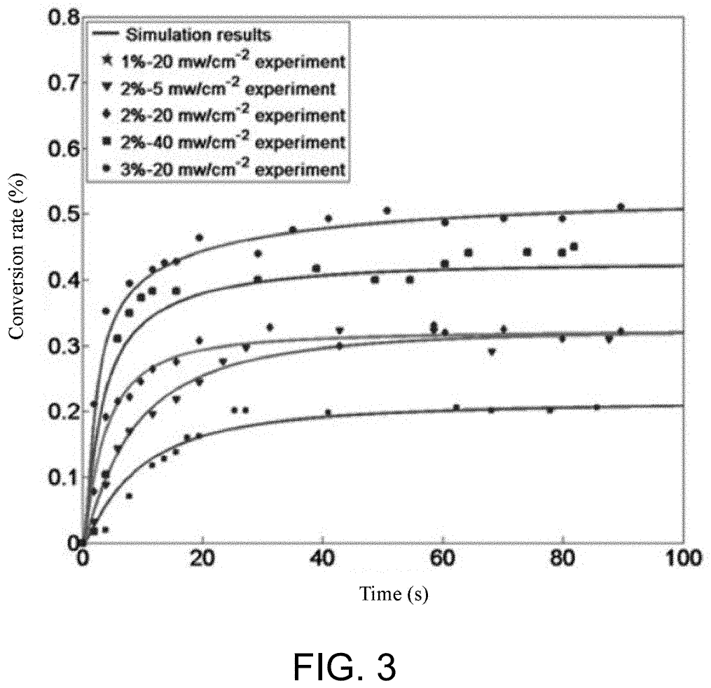

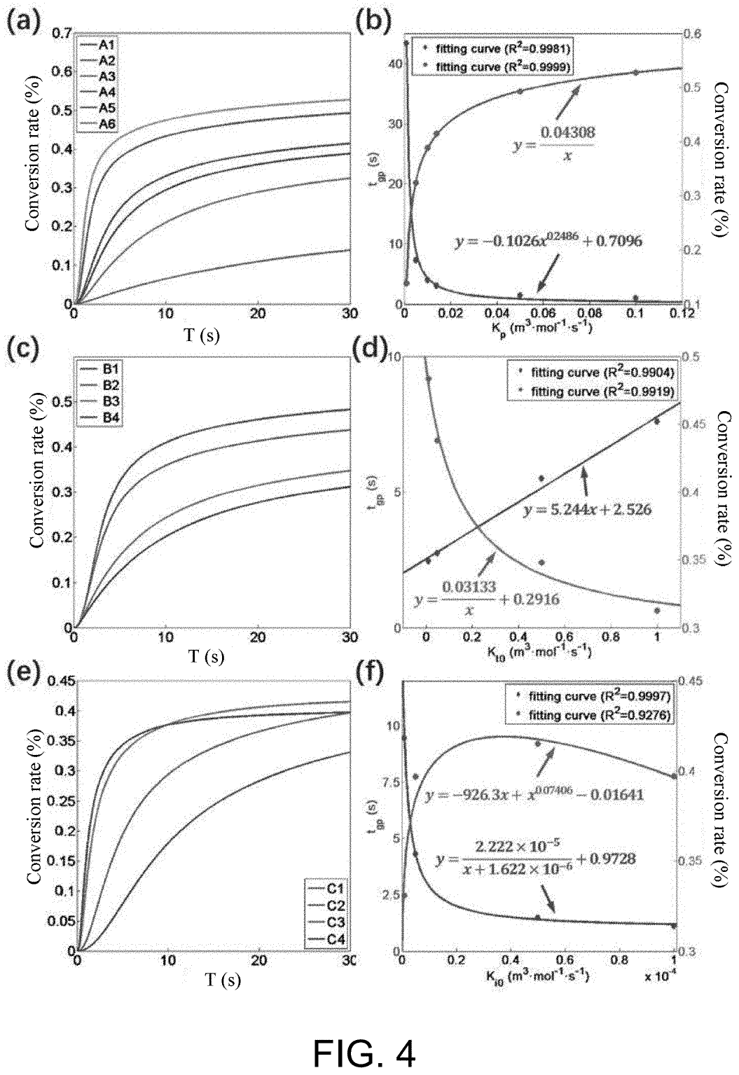

According to infrared spectrum data of the monomer, a characteristic peak is selected, a monomer conversion curve is calculated according to the decrease of an absorption peak relative to an initial state, and a monomer conversion curve with different curing parameters is obtained according to experimental results of different initiator concentrations. Calculation parameters such as a calculation step size, a grid size, and an area size, curing parameters such as a light source intensity, a layer thickness and an exposure time of single layer, physical properties such as resin monomer and initiator densities, a molar absorption coefficient, a temperature, and an initial molar concentration, and estimated values of reaction kinetic constants such as a chain initiation constant, a chain growth constant, and a termination constant are set. A calculation program automatically calculates experimental values of the reaction kinetic constants according to input parameters. A monomer infrared spectrum absorption characteristic peak-monomer concentration curve is shown in FIG. 2. It can be seen from FIG. 2 that an intensity of infrared spectrum absorption characteristic peak has a linear relationship with a monomer concentration. A monomer conversion curve of different curing parameters obtained by infrared spectrum data and simulation calculation data is shown in FIG. 3. It can be seen from FIG. 3 that the infrared spectrum data and the simulation calculation data have a high degree of matching. A calculation result of the photosensitive resin kinetic constants is shown in FIG. 4. It can be seen from FIG. 4 that the change of the kinetic constants causes the change of the simulation calculation conversion rate curve. Through a plurality of iterations of the kinetic constants, the conversion rate curve and an experimental curve gradually approaches, and a kinetic constant when it finally agrees with the experimental results is the kinetic constant of the experimental data. Photo-curing calculation parameter values refer to Table 1.

| Parameter | | | |
|---|---|---|---|
| name | Unit | Value | Meaning |
| ρₘ | kg · m⁻³ | 1.17E+00 | Monomer density |
| ρₚ | kg · m⁻³ | 1.22E+00 | Polymer density |
| αₘ | K⁻¹ | 8.86E−04 | Monomer thermal |
| | | | expansion coefficient |
| αₚ | K⁻¹ | 1.30E−04 | Polymer thermal |
| | | | expansion coefficient |
| T_{gm} | K | 2.26E+02 | Monomer glass transition |
| | | | temperature |
| T_{gp} | K | 3.58E+02 | Polymer glass transition |
| | | | temperature |
| Aₚ | — | 8.60E−01 | Self-accelerating growth |
| | | | constant |
| Aₜ | — | 2.28E+01 | Self-accelerating |
| | | | termination constant |
| kₚ₀ | m³ · mol⁻¹ · s⁻¹ | 1.40E−02 | Ideal growth constant |
| kₜ₀ | m³ · mol⁻¹ · s⁻¹ | 1.00E−01 | Ideal termination constant |
| f_{cp} | — | 7.50E−02 | Critical growth free |
| | | | volume fraction |
| f_{ct} | — | 5.81E−02 | Critical termination free |
| | | | volume fraction |
| R | — | 1.10E+01 | Reaction diffusion |
| | | | transformation constant |
| kₒ | m³ · mol⁻¹ · s⁻¹ | 5.00E+05 | Oxygen inhibition kinetic |
| | | | constant |
| ϕ | — | 3.00E−02 | Quantum efficiency |
| ε | m³ · mol⁻¹ · s⁻¹ | 5.42E+01 | Initiator molar absorption |
| | | | coefficient |
| A₀ | m⁻¹ | 1.00E+04 | Additive background |
| | | | absorption |
| A₀ₗ | m⁻¹ | 1.69E+01 | Liquid background |
| | | | absorption |
| A₀ₛ | m⁻¹ | 1.35E+03 | Solid background |
| | | | absorption |
| I₀ | mW · cm⁻² | 2.00E+01 | Incident light intensity |
| T | K | 2.98E+02 | temperature |
| [PI]₀ | mol · m⁻³ | 3.26E+01 | Initial photoinitiator |
| | | | concentration |
| [M]₀ | mol · m⁻³ | 5.84E+03 | Initial monomer |
| | | | concentration |
| Dₒ | m² · s⁻¹ | 1.08E−10 | Oxygen diffusion |
| | | | coefficient |
| [O₂]₀ | mol · m⁻³ | 1.30E−02 | Initial oxygen |
| | | | concentration |
| kᵢ | s⁻¹ | 1.00E−05 | Primary free radical |
| | | | kinetic constant |
| Step | s | 1.00E−05 | Simulation step size |
| Scale | m · px⁻¹ | 1.00E−05 | Scale setting |

Step 3, a photo-curing three dimensional printing curing process is calculated.

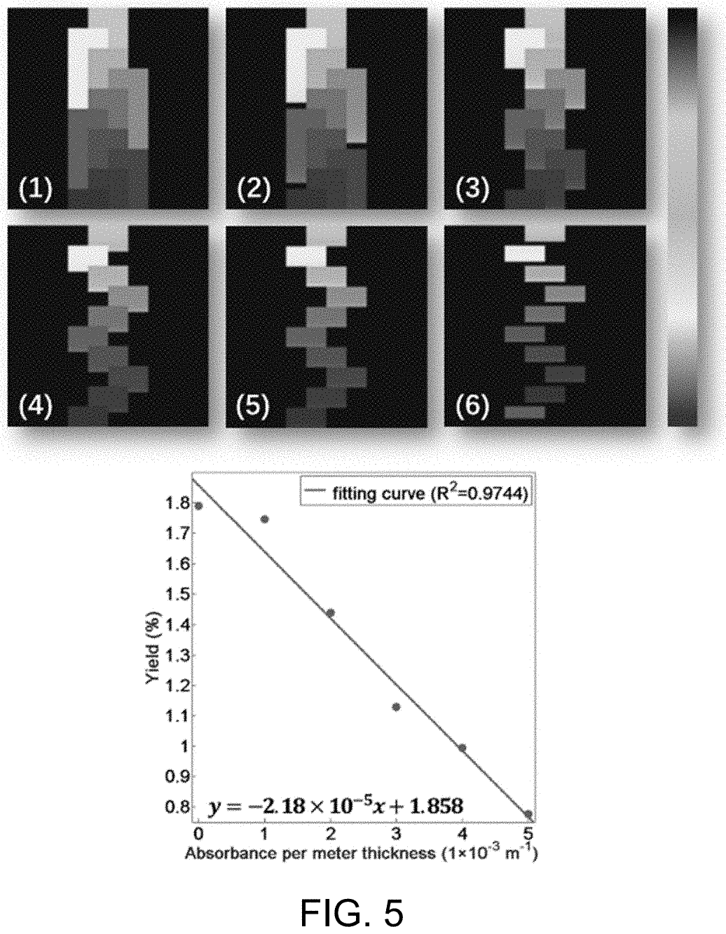

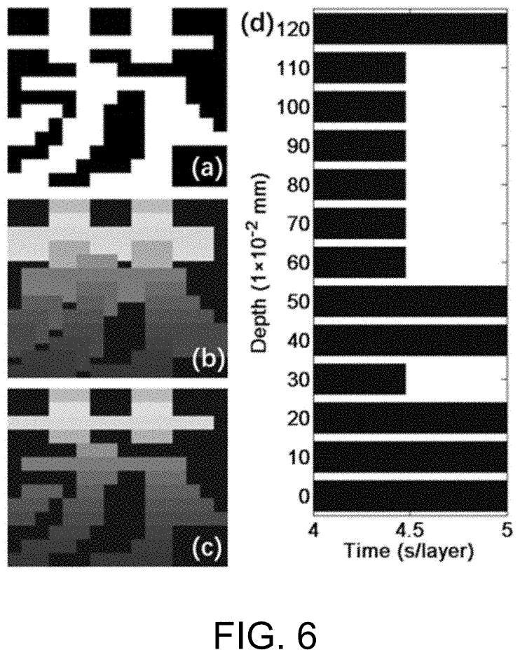

A three dimensional model file is input, the calculation parameters and the curing parameters are set, and the program simulates the curing process according to the settings, finally outputs time and space distribution data of various parameters including the monomer conversion rate, the light intensity, and the initiator concentration, and generates a three dimensional printing molding effect preview according to the calculation data. The comparison of the curing thickness of a three dimensional printing layer under different additive concentrations refers to FIG. 5. FIG. 5 shows the spatial distribution of the conversion rate of the curing monomer simulated by the photo-curing three dimensional printing at the last moment. It can be seen that the higher the absorbance of the photo-curing three dimensional printing resin, the smaller a curing depth, the smaller the layer thickness. The comparison of the three dimensional printing molding effect of different single-layer exposure time refers to FIG. 6. It can be seen that the exposure time has a greater impact on the quality of photo-curing molding, and the quality of photo-curing molding is greatly improved after the optimization of the three dimensional printing preview.

1. A photo-curing three dimensional printing preview method, wherein comprising the following steps:
step 1, obtaining a relationship curve between a conversion rate and time of a photosensitive resin system under different curing conditions by measuring a relationship between an absorbance and time of the photosensitive resin system under different curing conditions;
step 2, fitting an experimental curve by using an iterative solution method based on a photo-curing kinetic equation, obtaining a photo-curing kinetic constant of the photosensitive resin system, and establishing a photo-curing reaction kinetic differential equation set;
step 3, solving the photo-curing reaction kinetic differential equation set by using a fixed-step Euler method, and obtaining a spatial distribution and time relationship curve of a content of each component of the photosensitive resin system in a photo-curing reaction process;
step 4, measuring a relationship curve between an incident light transmissivity and a thickness of a cured product before and after a photo-curing reaction of the photosensitive resin system through a UV spectrum; and
step 5, performing simulated printing according to a structure of a three dimensional printing product, a light source intensity, a layer thickness and single-layer printing time, obtaining spatial distribution of the content of each component in each layer structure in the three dimensional printing product after printing is completed by combining with the spatial distribution and time relationship curve of the content of each component of the photosensitive resin system in the photo-curing reaction process, and completing photo-curing three dimensional printing preview.

2. The photo-curing three dimensional printing preview method according to claim 1, wherein the step 1 is specifically as follows: measuring a change situation of an absorbance of functional groups with time in 3-7 groups of photosensitive resins under the different curing conditions by using an in-situ Fourier transform infrared spectrometer, and converting the change situation into a change curve of the conversion rate with time through an internal standard method, wherein, the different curing conditions comprise different UV light source intensities and different photoinitiator contents.

3. The photo-curing three dimensional printing preview method according to claim 1, wherein the photo-curing kinetic constant obtained in the step 2 comprises a chain initiation constant, a chain growth constant and a termination constant.

4. The photo-curing three dimensional printing preview method according to claim 1, wherein the photo-curing reaction kinetic differential equation set in the step 2 is obtained by simultaneously obtaining reaction rate equations comprising initiator decomposition, chain initiation, chain growth, and chain termination.
